(19) United States
(12) Patent Application Publication
(10) Pub. No.: US 2024/0083064 A1
(43) Pub. Date: Mar. 14, 2024

(54) METHOD OF CUTTING A HOLE IN AN OSTOMY BARRIER

(71) Applicant: David A. Keilman, Crown Point, IN (US)

(72) Inventor: David A. Keilman, Crown Point, IN (US)

(21) Appl. No.: 17/944,177

(22) Filed: Sep. 13, 2022

(51) Int. Cl. B26F 1/14

(52) U.S. Cl. CPC B26F 1/14

(57) ABSTRACT

A method of cutting a hole in an ostomy barrier for fitting an ostomy bag to a stoma includes a method for cutting a hole in an ostomy barrier. The method uses a tool system for providing an impact from a spring-biased driver member transferred to a punch having an annular cutting edge. The tool system punches a circular hole into the ostomy barrier which is adapted to fit around a stoma by placing the barrier on a rigid surface, positioning the annular cutting edge on the barrier opposite the rigid surface, and urging the driver member to impact the ostomy barrier.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to methods for cutting holes in ostomy barriers and more particularly pertains to a new method for cutting holes in ostomy barriers for fitting an ostomy bag to a stoma.

### (2) Description of Related Art Including Information Disclosed Under 37 CFR 1.97 and 1.98

The prior art relates to methods for cutting holes in ostomy barriers which utilize devices which either press the ostomy barrier between a cutting edge and another surface or cut holes using a circular razor twisted along a helical path into the ostomy barrier. However, the prior art does not disclose a device which forces an annular cutting edge impactfully into the ostomy barrier to form the hole.

### BRIEF SUMMARY OF THE INVENTION

An embodiment of the disclosure meets the needs presented above by generally comprising a method for cutting a hole in an ostomy barrier. The method uses a tool system for providing an impact from a spring-biased driver member transferred to a punch having an annular cutting edge. The tool system punches a circular hole into the ostomy barrier which is adapted to fit around a stoma by placing the barrier on a rigid 25 surface, positioning the annular cutting edge on the barrier opposite the rigid surface, and urging the driver member to impact the ostomy barrier.

There has thus been outlined, rather broadly, the more important features of the disclosure in order that the detailed description thereof that follows may be better 30 understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a portion of a tool system of an embodiment of the disclosure.

FIG. 2 is a front in-use view of a portion of a tool system of an embodiment of the disclosure.

FIG. 3 is a side exploded view of a portion of a tool system of an embodiment of the disclosure.

FIG. 4 is a bottom view of a plurality of punches of an embodiment of the disclosure.

FIG. 5 is a top view of a portion of a tool system of an embodiment of the 25 disclosure.

FIG. 6A and FIG. 6B are cross-sectional views of a portion of a tool system of an embodiment of the disclosure from the arrows 6-6 in FIG. 5.

### DETAILED DESCRIPTION OF THE INVENTION

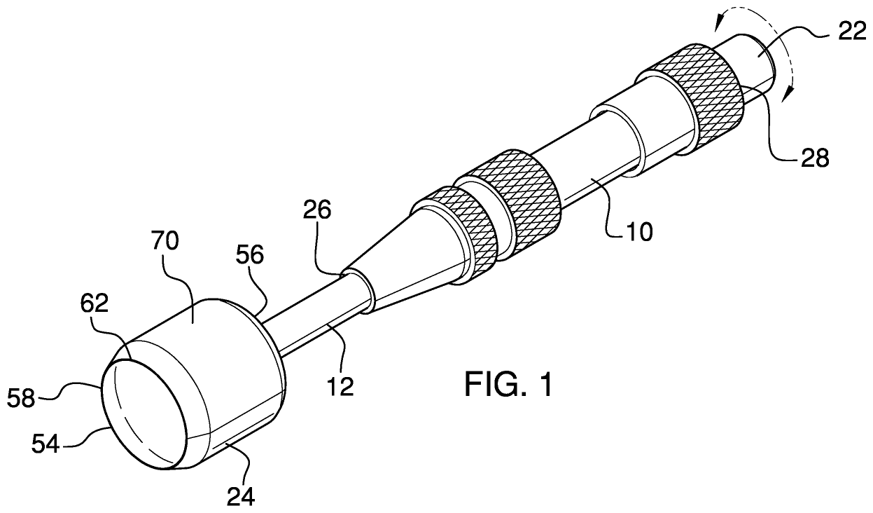

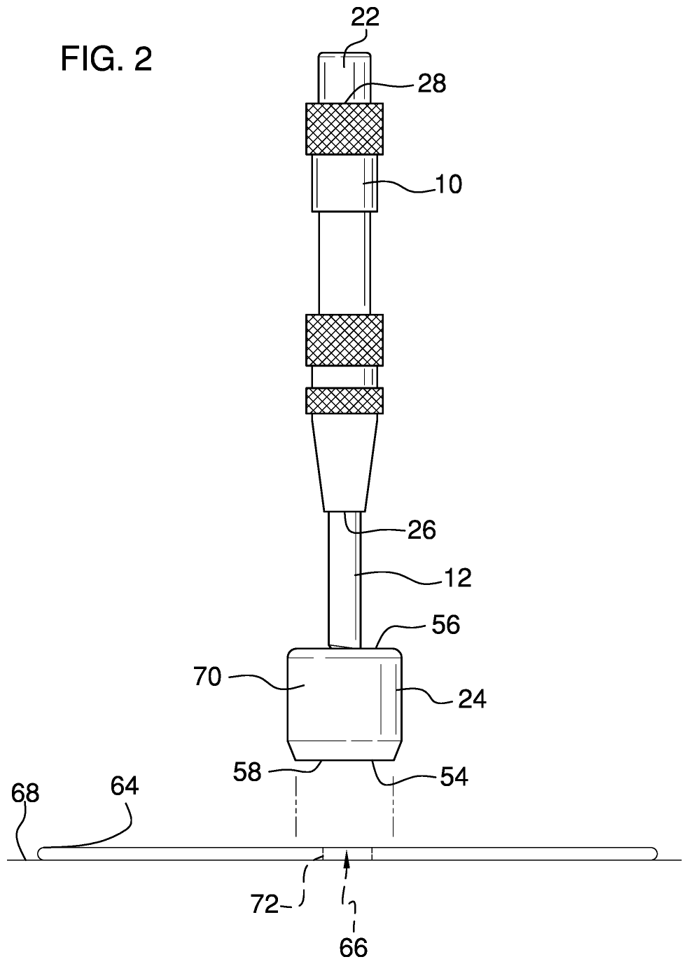

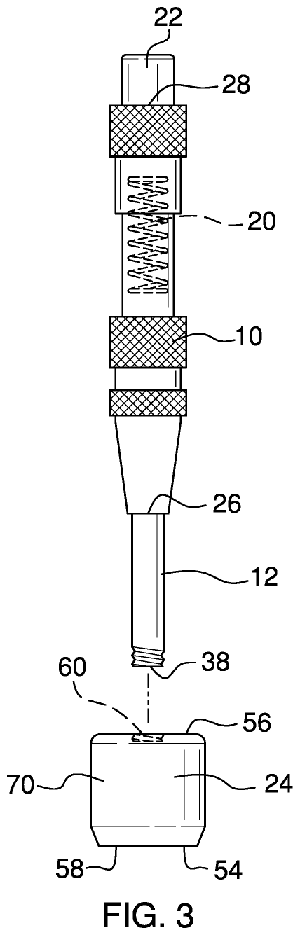

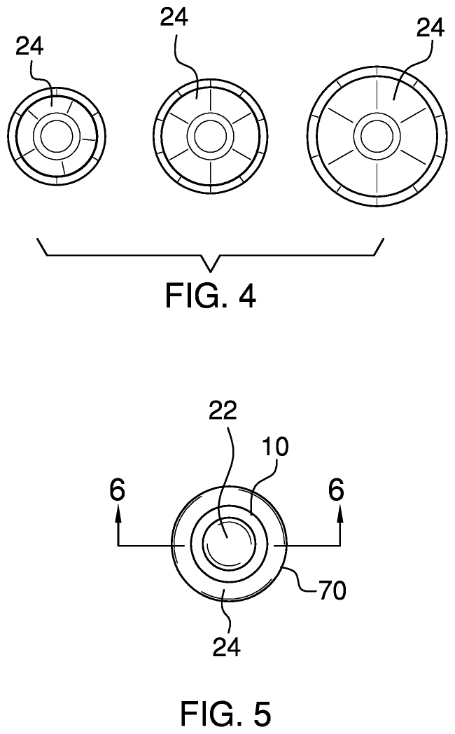

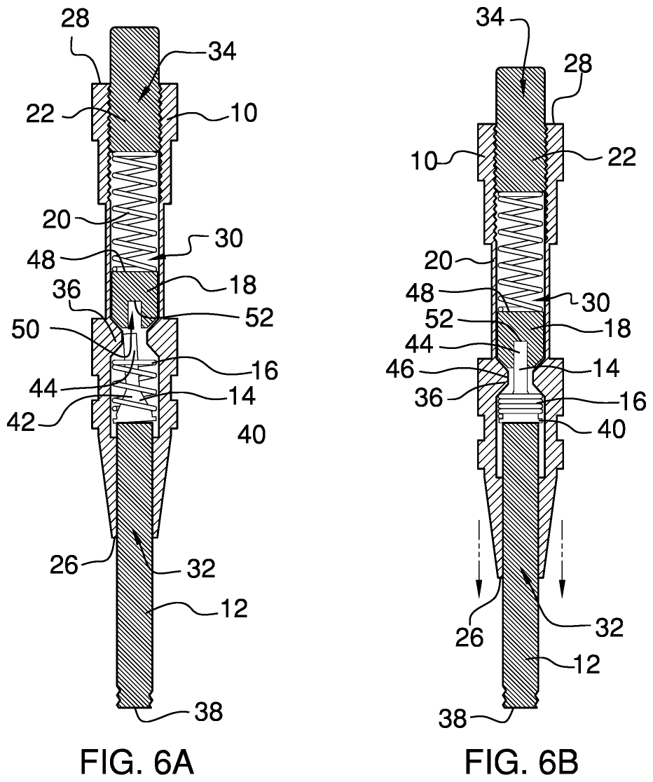

With reference now to the drawings, and in particular to FIGS. 1 through 6 thereof, a new method for cutting holes in ostomy barriers embodying the principles and concepts of an embodiment of the disclosure and generally designated by the reference numeral 10 will be described.

As best illustrated in FIGS. 1 through 6, the method of cutting a hole in an ostomy barrier 10 generally comprises providing an ostomy barrier hole punch 24 tool system. The ostomy barrier hole punch 24 tool system comprises a handle 10, a rod 12, an alignment pin 14, a first compression spring 16, a driver member 18, a second compression spring 20, a spring engagement member 22, and a plurality of punches 24. The handle 10 has a first end 26 and a second end 28 and defines a chamber 30 with the first end 26 defining a first opening 32 and the second end 28 defining a second opening 34 to the chamber 30. The handle 10 has a collar portion 36 protruding into the chamber 30. The rod 12 is received through the first opening 32 and has an exterior end 38 relative to the handle 10, the exterior end 38 being threaded. The alignment pin 14 is positioned within the chamber 30 and has a lip portion 40, a tapering portion 42, and a shaft portion 44. The tapering portion 42 is coupled to the lip portion 40 and the shaft portion 44 and tapers from the lip portion 40 to the shaft portion 44. The lip portion 40 engages the rod 12, and the shaft portion 44 is received through the collar portion 36 of the handle 10. A first compression spring 16 is positioned around the alignment pin 14 between the collar portion 36 of the handle 10 and the lip portion 40 of the alignment pin 14, wherein the first compression spring 16 is compressible between the lip portion 40 of the alignment pin 14 and the collar portion 36 of the handle 10. Alternatively, the alignment pin 14 may be spring biased away from said collar portion 36 toward said first end 26 of said handle 10 with a tension spring, torsion spring, or the like.

The driver member 18 is positioned adjacent the collar portion 36 of the handle 10 between the collar portion 36 and the second end 28 of the handle 10. The driver member 18 has a first end 46 and a second end 48. A cavity 50 extends into the first end 46 of the driver member 18 for receiving the shaft portion 44 of the alignment pin 14. The cavity 50 defines a recessed surface 52 for impactfully engaging the shaft portion 44 of the alignment pin 14. The second compression spring 20 is positioned within the chamber 30 adjacent the second end 28 of the driver member 18. The spring engagement member 22 is received through the second opening 34 to the chamber 30 and is adjacent the second compression spring 20, wherein the second compression spring 20 is compressible between the driver member 18 and the spring engagement member 22. The spring engagement member 22 is threadably coupled to the handle 10 and positionable along a range of distances from the driver member 18 whereby a driver force exerted by the second compression spring 20 when compressed is adjustable. Alternatively, the driver member 18 may be spring biased toward said alignment pin 14 via a tension spring, torsion spring, or the like which exerts the driver force on the driver member 18.

Each of the plurality of punches 24 has a first end 54 and a second end 56. The first end 54 of the punch 24 has an annular cutting edge 58, and the second end 56 of the punch 24 has a threaded surface 60 for removably coupling to the rod 12. The annular cutting edge 58 of each of the plurality of punches 24 has a differently sized diameter 62 to each other for cutting holes of different sizes.

The method further comprises providing an ostomy barrier 64 having an original aperture 66 extending therethrough and positioning the ostomy barrier 64 against a provided rigid surface 68. The rigid surface 68 must be rigid enough to apply a force with one of the plurality of punches 24 against the ostomy barrier 64 opposite the rigid surface 68 as further described below such that the ostomy barrier 64 is cut. A selected punch 70 is chosen from the plurality of punches 24 which has an annular cutting edge 58 with a diameter 62 corresponding to a diameter of an outer surface of a stoma, and the selected punch 70 is attached to the exterior end 38 of the rod 12. The annular cutting edge 58 of the selected punch 70 is positioned on the ostomy barrier 64 opposite the rigid surface 68 such that the annular cutting edge 58 surrounds the original aperture 66.

The handle 10 is then urged toward the selected punch 70, whereby the handle 10 moves toward the exterior end 38 of the rod 12, thereby compressing the first compression spring 16. The alignment pin 14 thereafter engages the driver member 18 and moves the driver member 18 toward the second end 28 of the handle 10, thereby compressing the second compression spring 20. The collar portion 36 of the handle 10 then engages the tapering portion 42 of the alignment pin 14 such that the shaft portion 44 of the alignment pin 14 aligns with the cavity 50 of the driver member 18. The second compression spring 20 accordingly urges the recessed surface 52 of the driver member 18 toward the alignment pin 14 such that the recessed surface 52 impacts the shaft portion 44 of the alignment pin 14. This impact causes the selected punch 70 to impactfully engage the ostomy barrier 64 along the annular cutting edge 58 such that a new aperture is formed in the ostomy barrier 64 in replacement of the original aperture 66, wherein the new aperture will have a diameter greater than a diameter 72 of the original aperture 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method for cutting a hole in an ostomy barrier comprising:
providing an ostomy barrier hole punch tool system comprising:
a handle having a first end and a second end, said handle defining a chamber with said first end defining a first opening and said second end defining a second opening to said chamber, said handle having a collar portion protruding into said chamber;
a rod being received through said first opening, said rod having an exterior end relative to said handle;
an alignment pin being positioned within said chamber, said alignment pin having a tapering portion and a shaft portion, said tapering portion being coupled to said shaft portion and tapering toward said shaft portion, said alignment pin engaging said rod, said shaft portion being received through said collar portion of said handle, said alignment pin being spring biased away from said collar portion toward said rod;
a driver member being positioned adjacent said collar portion of said handle between said collar portion and said second end of the handle, said driver member having a first end and a second end, said driver member having a cavity on said first end for receiving said shaft portion of said alignment pin, said cavity defining a recessed surface for impactfully engaging said shaft portion of said alignment pin, said driver member being spring biased toward said alignment pin, a driver force urging said drive member toward said alignment pin being adjustable; and
a punch having an annular cutting edge, said punch being positionable in a use configuration wherein said punch is attached to said rod such that said annular cutting edge faces away from said rod;
providing an ostomy barrier;
providing a rigid surface;
positioning said ostomy barrier against said rigid surface;
positioning said annular cutting edge of said punch on said ostomy barrier opposite said rigid surface;
urging said handle toward said punch;
said handle moving toward said exterior end of said rod;
said alignment pin engaging said driver member and moving said driver member toward said second end of said handle;
said collar portion of said handle engaging said tapering portion of said alignment pin such that said shaft portion of said alignment pin aligns with said cavity of said driver member;
said driver force urging said recessed surface of said driver member toward said alignment pin such that said recessed surface impactfully engages said shaft portion of said alignment pin; and
said punch impactfully engaging said ostomy barrier along said annular cutting edge such that an aperture is formed in said ostomy barrier.

2. The method of claim 1, further comprising:
said alignment pin having a lip portion coupled to said tapering portion opposite said shaft portion, said lip portion engaging said rod;
a compression spring being positioned around said alignment pin between said collar portion of said handle and said lip portion of said alignment pin, wherein said first compression spring is compressible between said lip portion of said alignment pin and said collar portion of said handle; and
said compression spring compressing between said collar portion of said handle and said lip portion of said alignment pin when said handle is moved toward said exterior end of said rod.

3. The method of claim 1, further comprising:
a compression spring being positioned within said chamber adjacent said second end of said driver member;
a spring engagement member being positioned adjacent said compression spring opposite said driver member, wherein said second compression spring is compressible between said driver member and said spring engagement member;
said compression spring compressing between said driver member and said spring engagement member when said alignment pin moves said driver member toward said second end of said handle; and
said compression spring exerting said driver force such that said recessed surface of said driver member impactfully engages said shaft portion of said alignment pin.

4. The method of claim 3, further comprising said spring engagement member being positionable along a range of distances from said driver member whereby said driver force is adjustable.

5. The method of claim 4, further comprising said spring engagement member being received through said second opening to said chamber and being threadably coupled to said handle.

6. The method of claim 1, further comprising said punch being permanently attached to said rod.

7. The method of claim 1, further comprising:
said punch being a selected punch of a plurality of punches, said annular cutting edge of each of said plurality of punches having a differently sized diameter to each other, said selected punch having a diameter corresponding to an outer surface of a stoma; and
attaching said selected punch to said exterior end of said rod before positioning said annular cutting edge of said selected punch on said ostomy barrier.

8. The method of claim 7, further comprising said exterior end of said rod being threaded, said plurality of punches having a threaded surface opposite said annular cutting edge for removably coupling to said rod.

9. The method of claim 1, further comprising
said aperture being a new aperture;
said ostomy barrier having an original aperture extending therethrough;
said annular cutting edge surrounding said original aperture when positioning said annular cutting edge of said punch on said ostomy barrier opposite said rigid surface; and
said new aperture being formed in said ostomy barrier in replacement of said original aperture, said new aperture having a diameter greater than a diameter of said original aperture.

10. A method of cutting a hole in an ostomy barrier comprising:
providing an ostomy barrier hole punch tool system comprising:
a handle having a first end and a second end, said handle defining a chamber with said first end defining a first opening and said second end defining a second opening to said chamber, said handle having a collar portion protruding into said chamber;
a rod being received through said first opening, said rod having an exterior end relative to said handle, said exterior end being threaded;
an alignment pin being positioned within said chamber, said alignment pin having a lip portion, a tapering portion, and a shaft portion, said tapering portion being coupled to said lip portion and said shaft portion and tapering from said lip portion to said shaft portion, said lip portion engaging said rod, said shaft portion being received through said collar portion of said handle;
a first compression spring being positioned around said alignment pin between said collar portion of said handle and said lip portion of said alignment pin, wherein said first compression spring is compressible between said lip portion of said alignment pin and said collar portion of said handle;
a driver member being positioned adjacent said collar portion of said handle between said collar portion and said second end of the handle, said driver member having a first end and a second end, said driver member having a cavity on said first end for receiving said shaft portion of said alignment pin, said cavity defining a recessed surface for impactfully engaging said shaft portion of said alignment pin;
a second compression spring being positioned within said chamber adjacent said second end of said driver member;
a spring engagement member being received through said second opening to said chamber and being adjacent said second compression spring, wherein said second compression spring is compressible between said driver member and said spring engagement member, said spring engagement member being positionable along a range of distances from said driver member whereby a driver force exerted by said second compression spring when compressed is adjustable, said spring engagement member being threadably coupled to said handle; and
a plurality of punches, each of said plurality of punches having a first end and a second end, said first end of said punch having an annular cutting edge, said second end of said punch having a threaded surface for removably coupling to said rod, said annular cutting edge of each of said plurality of punches having a differently sized diameter to each other;
providing an ostomy barrier, said ostomy barrier having an original aperture extending therethrough;
providing a rigid surface;
positioning said ostomy barrier against said rigid surface;
selecting a selected punch having a diameter corresponding to an outer surface of a stoma from said plurality of punches;
attaching said selected punch to said exterior end of said rod;
positioning said annular cutting edge of said selected punch on said ostomy barrier opposite said rigid surface such that said annular cutting edge surrounds said original aperture;
urging said handle toward said selected punch;
said handle moving toward said exterior end of said rod, thereby compressing said first compression spring;
said alignment pin engaging said driver member and moving said driver member toward said second end of said handle, thereby compressing said second compression spring;
said collar portion of said handle engaging said tapering portion of said alignment pin such that said shaft portion of said alignment pin aligns with said cavity of said driver member;
said second compression spring urging said recessed surface of said driver member toward said alignment pin such that said recessed surface impactfully engages said shaft portion of said alignment pin; and
said selected punch impactfully engaging said ostomy barrier along said annular cutting edge such that a new aperture is formed in said ostomy barrier in replacement of said original aperture, said new aperture having a diameter greater than a diameter of said original aperture.
